(19) United States
(12) Patent Application Publication
(10) Pub. No.: US 2023/0073027 A1
(43) Pub. Date: Mar. 9, 2023

(54) VEHICLE CONTROL SYSTEM AND METHOD, COMPUTER DEVICE, MEDIUM, AND VEHICLE

(71) Applicant: NIO TECHNOLOGY (ANHUI) CO., LTD, Hefei City (CN)

(72) Inventors: Sebastian ZIEGLMEIER, Hefei (CN); Namdeo GAIKWAD, Shanghai (CN); Shengcong WANG, Shanghai (CN); Jiahao WANG, Shanghai (CN)

(21) Appl. No.: 17/895,787

(22) Filed: Aug. 25, 2022

(30) Foreign Application Priority Data
Aug. 31, 2021 (CN) 202111012558.8

(51) Int. Cl. B60W 30/06; B60W 50/02; B60W 60/00

(52) U.S. Cl. CPC B60W 30/06; B60W 50/0205; B60W 60/0015; B60W 2710/20; B60W 2720/106; B60W 2520/10; B60W 2520/14

(57) ABSTRACT

The disclosure relates to a vehicle control system, a vehicle control method, a computer device, a computer-readable storage medium, and a vehicle. A vehicle control system according to an aspect of the disclosure includes: an autonomous driving control module configured to generate first planning information and second planning information in real time based on vehicle environment information, vehicle status information, and vehicle destination information, where the second planning information is used for safe parking; and a vehicle dynamic control module configured to receive the first planning information and the second planning information from the autonomous driving control module in real time, to generate a first control instruction based on the received first planning information or generate a second control instruction based on the received second planning information.

### CROSS-REFERENCE TO RELATED APPLICATION

This application claims the benefit of China Patent Application No. 202111012558.8 filed Aug. 31, 2021, the entire contents of which are incorporated herein by reference in its entirety.

### TECHNICAL FIELD

The disclosure relates to the field of vehicle control, and more specifically, to a vehicle control system, a vehicle control method, a computer device, a computer storage medium, and a vehicle.

### BACKGROUND ART

As people constantly pursue safe and comfortable driving experience, autonomous driving technologies have become a new development trend of automobiles. The autonomous driving technologies rely on collaboration of computer vision, radars, monitoring apparatuses, global positioning systems, etc., to enable operations such as autonomous driving, steering, and braking of vehicles without active intervention of humans.

The autonomous driving technologies mainly rely on an autonomous driving controller to send a lateral control instruction and a longitudinal control instruction for a vehicle, to control the vehicle to operate. However, when the autonomous driving controller fails and thus cannot send the lateral control instruction and the longitudinal control instruction for the vehicle, a safety accident may occur in the vehicle, for example, the vehicle collides with another vehicle, drives out of a lane, etc. Therefore, how to avoid a vehicle safety accident caused by failure of the autonomous driving controller is crucial.

In a current vehicle autonomous driving system, a primary autonomous driving controller and an auxiliary autonomous driving controller are usually provided. When the primary autonomous driving controller fails, the auxiliary autonomous driving controller can take over from the primary autonomous driving controller to control a vehicle to park safely. However, the provision of the auxiliary autonomous driving controller additionally increases time consumption, complexity, and costs of designing the autonomous driving system. In addition, the primary autonomous driving controller and the auxiliary autonomous driving controller might fail at the same time. As a result, the provision of the auxiliary autonomous driving controller cannot even fully ensure the driving safety of an autonomous vehicle.

### SUMMARY OF THE DISCLOSURE

In order to solve or at least alleviate one or more of the above problems, the following technical solutions are provided.

According to a first aspect of the disclosure, a vehicle control system is provided, the system including: an autonomous driving control module configured to generate first planning information and second planning information in real time based on vehicle environment information, vehicle status information, and vehicle destination information, where the second planning information is used for safe parking; and a vehicle dynamic control module configured to receive the first planning information and the second planning information from the autonomous driving control module in real time, to generate a first control instruction based on the received first planning information or generate a second control instruction based on the received second planning information.

In the vehicle control system according to an embodiment of the disclosure, the vehicle dynamic control module is further configured to: detect a status of communication with the autonomous driving control module and an operating status of the autonomous driving control module in real time, to determine whether the autonomous driving control module has failed; and generate the first control instruction based on the received first planning information upon determining that the autonomous driving control module has not failed, and generate the second control instruction based on the received second planning information upon determining that the autonomous driving control module has failed.

In the vehicle control system according to an embodiment of the disclosure or any of the above embodiments, the vehicle dynamic control module is further configured to: determine that the autonomous driving control module has failed upon detecting that at least one of the status of communication with the autonomous driving control module and the operating status of the autonomous driving control module is abnormal; and determine that the autonomous driving control module has not failed upon detecting that the status of communication with the autonomous driving control module and the operating status of the autonomous driving control module are normal.

The vehicle control system according to an embodiment of the disclosure or any of the above embodiments further includes: a lateral control module configured to control steering of a vehicle based on the first control instruction or the second control instruction from the vehicle dynamic control module; and a longitudinal control module configured to control acceleration/deceleration of the vehicle based on the first control instruction or the second control instruction from the vehicle dynamic control module.

In the vehicle control system according to an embodiment of the disclosure or any of the above embodiments, the first control instruction includes a steering angle and an acceleration/deceleration value, and the vehicle dynamic control module is further configured to: send the steering angle to the lateral control module to control the steering of the vehicle; and send the acceleration/deceleration value to the longitudinal control module to control the acceleration/deceleration of the vehicle.

In the vehicle control system according to an embodiment of the disclosure or any of the above embodiments, the vehicle dynamic control module further includes a path tracking submodule, and the path tracking submodule is configured to perform a path tracking operation based on the second planning information, to generate the second control instruction.

In the vehicle control system according to an embodiment of the disclosure or any of the above embodiments, the path tracking submodule is further configured to perform a path tracking operation based on the second planning information, to generate the second control instruction by the following steps: determining, based on current position information, a current vehicle speed, and a current yaw angle of the vehicle, a steering angle deviation and a speed deviation required by the vehicle to follow the second planning information; generating the second control instruction based on the determined steering angle deviation and speed deviation required by the vehicle to follow the second planning information, where the second control instruction includes a steering angle control volume and an acceleration/deceleration value control volume; and controlling the lateral control module based on the steering angle control volume and controlling the longitudinal control module based on the acceleration/deceleration value control volume, so that the vehicle drives to a safe parking position according to the second planning information.

According to a second aspect of the disclosure, a vehicle control method is provided, the method including the following steps: generating first planning information and second planning information in real time based on vehicle environment information, vehicle status information, and vehicle destination information, where the second planning information is used for safe parking; detecting a status of communication between a vehicle dynamic control module and an autonomous driving control module and an operating status of the autonomous driving control module in real time, to determine whether the autonomous driving control module has failed; and generating the first control instruction based on the first planning information upon determining that the autonomous driving control module has not failed, and generating the second control instruction based on the second planning information upon determining that the autonomous driving control module has failed.

The vehicle control method according to an embodiment of the disclosure further includes: determining that the autonomous driving control module has failed upon detecting that at least one of the status of communication between the vehicle dynamic control module and the autonomous driving control module and the operating status of the autonomous driving control module is abnormal; and determining that the autonomous driving control module has not failed upon detecting that the status of communication between the vehicle dynamic control module and the autonomous driving control module and the operating status of the autonomous driving control module are normal.

In the vehicle control method according to an embodiment of the disclosure or any of the above embodiments, the first control instruction includes a steering angle and an acceleration/deceleration value, and the method further includes: controlling steering of a vehicle based on the steering angle; and controlling acceleration/deceleration of the vehicle based on the acceleration/deceleration value.

The vehicle control method according to an embodiment of the disclosure or any of the above embodiments further includes: performing a path tracking operation based on the second planning information, to generate the second control instruction.

In the vehicle control method according to an embodiment of the disclosure or any of the above embodiments, the performing a path tracking operation based on the second planning information, to generate the second control instruction is implemented by the following steps: determining, based on current position information, a current vehicle speed, and a current yaw angle of the vehicle, a steering angle deviation and a speed deviation required by the vehicle to follow the second planning information; generating the second control instruction based on the determined steering angle deviation and speed deviation required by the vehicle to follow the second planning information, where the second control instruction includes a steering angle control volume and an acceleration/deceleration value control volume; and controlling the vehicle to steer based on the steering angle control volume and controlling the vehicle to accelerate/decelerate based on the acceleration/deceleration value control volume, so that the vehicle drives to a safe parking position according to the second planning information.

According to a third aspect of the disclosure, there is provided a computer storage medium, which has a computer program stored thereon, where the program may be executed by a computer to implement the steps of the vehicle control method according to the second aspect of the disclosure.

According to a fourth aspect of the disclosure, there is provided a computer device, which includes a memory, a processor, and a computer program stored on the memory and executable on the processor, where the processor, when executing the program, implements the steps of the vehicle control method according to the second aspect of the disclosure.

According to a fifth aspect of the disclosure, there is provided a vehicle, which includes the vehicle control system according to the first aspect of the disclosure.

### BRIEF DESCRIPTION OF THE DRAWINGS

The above-mentioned and/or other aspects and advantages of the disclosure will become more apparent and more readily appreciated from the following description of various aspects in conjunction with the accompanying drawings, in which the same or similar units are denoted by the same reference numerals. In the accompanying drawings:

FIG. 1 is a block diagram of a vehicle control system according to an embodiment of the disclosure;

FIG. 2 is a flowchart of a vehicle control method according to an embodiment of the disclosure;

FIG. 3 is a schematic diagram of path tracking according to an embodiment of the disclosure; and

FIG. 4 is a block diagram of a computer device according to an embodiment of the disclosure.

### DETAILED DESCRIPTION OF EMBODIMENTS

In this specification, the disclosure is described more fully with reference to the accompanying drawings in which schematic embodiments of the disclosure are illustrated. However, the disclosure may be implemented in different forms, and should not be construed as being limited to the embodiments provided herein. The embodiments provided herein are intended to make the disclosure of this specification full and complete, to convey the scope of protection of the disclosure more fully to those skilled in the art.

The terms such as “include” and “comprise” are used to indicate that in addition to the units and steps that are directly and clearly described in this specification, other units and steps that are not directly or clearly described are not excluded in the technical solutions of the disclosure. The terms such as “first” and “second” are not used to indicate sequences of units in terms of time, space, size, etc., and are merely used to distinguish between the units.

It should be noted that the term “vehicle” in the disclosure is broadly construed as including any moving object, including, for example, an aircraft, a ship, a spacecraft, an automobile, a truck, a van, a semi-trailer, a motorcycle, a golf cart, an off-road vehicle, a warehouse transport vehicle, an agricultural vehicle, and a vehicle that drives on a track, such as a tram, a train, or other rail vehicles. The “vehicle” in the disclosure usually may include a power system, a sensor system, a control system, a peripheral device, and a computer system. In other embodiments, the vehicle may include more, fewer, or different systems.

Various exemplary embodiments according to the disclosure will be described below in detail with reference to the accompanying drawings.

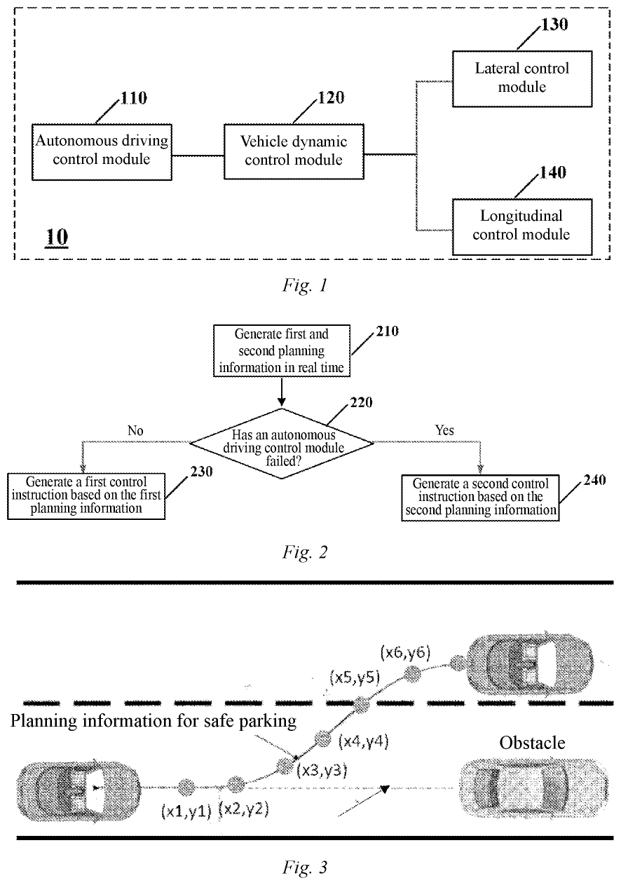

FIG. 1 is a block diagram of a vehicle control system according to an embodiment of the disclosure. As shown in FIG. 1, a vehicle control system 10 includes an autonomous driving control module 110, a vehicle dynamic control module 120, a lateral control module 130, and a longitudinal control module 140.

The autonomous driving control module 110 is configured to generate first planning information and second planning information in real time based on vehicle environment information, vehicle status information, and vehicle destination information, where the first planning information is used for normal driving of an autonomous vehicle, and the second planning information is used for safe parking of the autonomous vehicle. Optionally, the first planning information and the second planning information may include, but are not limited to, path planning information and trajectory planning information. In an example, the first planning information may be implemented as trajectory planning information, and the second planning information may be implemented as path planning information. In another example, the first planning information may be implemented as path planning information, and the second planning information may be implemented as trajectory planning information. However, those skilled in the art can understand that implementations of the first planning information and the second planning information are not limited the implementations described above. The first planning information and the second planning information can be implemented in any other planning manner without departing from the scope of the disclosure.

As an example, the vehicle environment information may include, but is not limited to: lane line information, a number of lanes, road boundary information, a road driving parameter, a traffic signal, green belt information, obstacle information, etc. in an environment where the vehicle is currently located. The vehicle status information may include, but is not limited to: a speed, an acceleration, a yaw angle, etc. of the vehicle. The vehicle destination information may include, but is not limited to: a destination that the vehicle intends to reach during normal driving, and a destination that the vehicle intends to reach during safe parking.

In an embodiment, the autonomous driving control module 110 may generate both the first planning information and the second planning information for the vehicle in real time in combination with a vehicle dynamics model and a vehicle kinematics model by using a planning information control algorithm based on the vehicle environment information, the vehicle status information, and the vehicle destination information. In the present specification, for a process of generating the first planning information and a second path for the vehicle in real time by using the planning information control algorithm, reference may be made to the related art, and details are not repeated here.

The vehicle dynamic control module 120 is configured to receive the first planning information and the second planning information from the autonomous driving control module 110 in real time, to generate a first control instruction based on the received first planning information or generate a second control instruction based on the received second planning information. Optionally, the vehicle dynamic control module 120 is further configured to: detect a status of communication with the autonomous driving control module 110 and an operating status of the autonomous driving control module 110 in real time, to determine whether the autonomous driving control module 110 has failed; and generate the first control instruction based on the received first planning information upon determining that the autonomous driving control module 110 has not failed, and generate the second control instruction based on the received second planning information upon determining that the autonomous driving control module 110 has failed. It can be understood that the failure of the autonomous driving control module 110 may include, but is not limited to: loss of power supply, a hardware failure, a software error, etc. Optionally, the vehicle dynamic control module 120 is further configured to: determine that the autonomous driving control module 110 has failed upon detecting that at least one of the status of communication with the autonomous driving control module 110 and the operating status of the autonomous driving control module 110 is abnormal; and determine that the autonomous driving control module 110 has not failed upon detecting that the status of communication with the autonomous driving control module 110 and the operating status of the autonomous driving control module 110 are normal.

In an embodiment, the first control instruction may include a steering angle and an acceleration/deceleration value, and the vehicle dynamic control module 120 is further configured to: send the steering angle to the lateral control module 130 to control steering of the vehicle; and send the acceleration/deceleration value to the longitudinal control module 140 to control acceleration/deceleration of the vehicle.

In another embodiment, the vehicle dynamic control module 120 may compute a steering angle control instruction based on the first planning information and a current steering angle, and send the steering angle control instruction to the lateral control module 130 to control the steering of the vehicle. As an example, the lateral control module 130 may be implemented as an electrical power steering (EPS) mechanism. In another embodiment, the vehicle dynamic control module 120 may compute an acceleration/deceleration control instruction (for example, a gear control instruction, an acceleration instruction, or a braking instruction) based on the first planning information, a current vehicle speed, and a target vehicle speed, and send the acceleration/deceleration control instruction to the longitudinal control module 140 to control the acceleration/deceleration of the vehicle. As an example, the longitudinal control module 140 may be implemented as an engine/motor control unit and a braking control unit.

The vehicle dynamic control module 120 further includes a path tracking submodule (not shown in FIG. 1), and the path tracking submodule is configured to perform a path tracking operation based on the second planning information, to generate the second control instruction. Optionally, the path tracking submodule is further configured to perform a path tracking operation based on the second planning information, to generate the second control instruction by the following steps: determining, based on current position information, a current vehicle speed, and a current yaw angle of the vehicle, a steering angle deviation and a speed deviation required by the vehicle to follow the second planning information; generating the second control instruction based on the determined steering angle deviation and speed deviation required by the vehicle to follow the second planning information, where the second control instruction includes a steering angle control volume and an acceleration/deceleration value control volume; and controlling the lateral control module 130 based on the steering angle control volume and controlling the longitudinal control module 140 based on the acceleration/deceleration value control volume, so that the vehicle drives to a safe parking position according to the second planning information.

In an embodiment, in a process of performing the path tracking operation based on the second planning information, the path tracking submodule may be configured to: obtain position information of discrete points included in a path in the second planning information, and current position information, a current speed, and a current yaw angle of the vehicle, and perform the path tracking operation based on the obtained position information of the discrete points included in the path in the second planning information, and the obtained current position information, current speed, and current yaw angle of the vehicle. Specifically, the vehicle dynamic control module 120 may be configured to: determine a target yaw angle of the vehicle based on the position information of the discrete points included in the path in the second planning information, and the current position information of the vehicle; determine a target steering angle of the vehicle based on the current yaw angle, the target yaw angle, and the current speed of the vehicle; determine a target speed of the vehicle based on the position information of the discrete points included in the path in the second planning information and the current yaw angle; generate a steering angle control volume and an acceleration/deceleration value control volume respectively based on the determined target steering angle and target speed of the vehicle; and control the lateral control module 130 based on the generated steering angle control volume and control the longitudinal control module 140 based on the generated acceleration/deceleration value control volume, so that the vehicle drives to a safe parking position according to the second planning information.

In another embodiment, in the process of performing the path tracking operation based on the second planning information, the path tracking submodule may be configured to: obtain position information of discrete points included in a path in the second planning information, and current position information, a current speed, and a current yaw angle of the vehicle; select, from the discrete points included in the path in the second planning information, a discrete point closest to a current position of the vehicle as a target tracking point; determine a look-ahead distance l_{d} from the current position of the vehicle (such as a position of a rear axle) to the target tracking point; determine an included angle α between a current vehicle body attitude of the vehicle and the target tracking point; determine a target steering angle δ(t) of the vehicle based on the following formula:

$$δ ( t ) = {tan}^{- 1} ( \frac{2 L sin ( α ( t ) )}{{l}_{d}} )$$

where L represents a wheelbase of the vehicle, and α(t) represents an included angle between a vehicle body attitude and the target tracking point at a time t; determine a target speed of the vehicle based on the current speed and a desired speed of the vehicle; generate a steering angle control volume and an acceleration/deceleration value control volume respectively based on the determined target steering angle and target speed of the vehicle; and control the lateral control module 130 based on the generated steering angle control volume and control the longitudinal control module 140 based on the generated acceleration/deceleration value control volume, so that the vehicle drives to a safe parking position according to the second planning information.

Those skilled in the art may understand that the foregoing embodiment of the process of the path tracking operation is only used as an example. Without departing from the spirit and the scope of the disclosure, the path tracking submodule according to the disclosure may perform the path tracking operation based on the second planning information in other path tracking manners, to generate the second control instruction to control the lateral control module 130 and the longitudinal control module 140, so that the vehicle drives to a safe parking position according to the second planning information.

The vehicle control system 10 according to an aspect of the disclosure may be applied to an autonomous driving process of a vehicle. During normal driving of the vehicle, the autonomous driving control module 110 may generate, in real time, both planning information for normal driving of the vehicle and planning information for safe parking when the autonomous driving control module 110 fails, and also send same to the vehicle dynamic control module 120. This ensures that when the autonomous driving control module 110 fails, the vehicle dynamic control module 120 may perform the path tracking operation based on the previously received planning information for safe parking, to control the vehicle to drive to a safe parking position, without the need of an additional autonomous driving control module for control.

According to the above vehicle control system 10, only a single autonomous driving control module 110 may be used, and safe parking of the autonomous vehicle when the autonomous driving control module 110 fails may be implemented. This improves the autonomous driving safety of the vehicle while reducing the complexity and costs of designing the autonomous driving system.

FIG. 2 is a flowchart of a vehicle control method according to an embodiment of the disclosure.

Step 210 involves generating first planning information and second planning information in real time based on vehicle environment information, vehicle status information, and vehicle destination information, where the first planning information is used for normal driving of an autonomous vehicle, and the second planning information is used for safe parking of the autonomous vehicle. Optionally, the first planning information and the second planning information may include, but are not limited to, path planning information and trajectory planning information. In an example, the first planning information may be implemented as trajectory planning information, and the second planning information may be implemented as path planning information. In another example, the first planning information may be implemented as path planning information, and the second planning information may be implemented as trajectory planning information. However, those skilled in the art can understand that implementations of the first planning information and the second planning information are not limited the implementations described above. The first planning information and the second planning information can be implemented in any other planning manner without departing from the scope of the disclosure.

As an example, the vehicle environment information may include, but is not limited to: lane line information, a number of lanes, road boundary information, a road driving parameter, a traffic signal, green belt information, obstacle information, etc. in an environment where the vehicle is currently located. The vehicle status information may include, but is not limited to: a speed, an acceleration, a yaw angle, etc. of the vehicle. The vehicle destination information may include, but is not limited to: a destination that the vehicle intends to reach during normal driving, and a destination that the vehicle intends to reach during safe parking.

In an embodiment, both the first planning information and the second planning information for the vehicle may be generated in real time in combination with a vehicle dynamics model and a vehicle kinematics model by using a planning information control algorithm based on the vehicle environment information, the vehicle status information, and the vehicle destination information. In the present specification, for a process of generating the first planning information and a second path for the vehicle in real time by using the planning information control algorithm, reference may be made to the related art, and details are not repeated here.

Step 220 involves: detecting a status of communication between a vehicle dynamic control module and an autonomous driving control module and an operating status of the autonomous driving control module in real time, to determine whether the autonomous driving control module has failed; and proceeding to 230 of generating the first control instruction based on the first planning information upon determining that the autonomous driving control module has not failed, and proceeding to step 240 of generating the second control instruction based on the second planning information upon determining that the autonomous driving control module has failed. It can be understood that the failure of the autonomous driving control module may include, but is not limited to: loss of power supply, a hardware failure, a software error, etc. Optionally, it is determined that the autonomous driving control module has failed upon detecting that at least one of the status of communication between the vehicle dynamic control module and the autonomous driving control module and the operating status of the autonomous driving control module is abnormal; and it is determined that the autonomous driving control module has not failed upon detecting that the status of communication between the vehicle dynamic control module and the autonomous driving control module and the operating status of the autonomous driving control module are normal.

In an embodiment, the first control instruction may include a steering angle and an acceleration/deceleration value, and steering of a vehicle may be controlled based on the steering angle, and acceleration/deceleration of the vehicle may be controlled based on the acceleration/deceleration value.

In another embodiment, a steering angle control instruction may be computed based on the first planning information and a current steering angle, to control the steering of the vehicle based on the steering angle control instruction. In another embodiment, an acceleration/deceleration control instruction (for example, a gear control instruction, an acceleration instruction, or a braking instruction) may be computed based on the first planning information, a current vehicle speed, and a target vehicle speed, to control the acceleration/deceleration of the vehicle based on the acceleration/deceleration control instruction.

Step 240 involves performing a path tracking operation based on the second planning information, to generate the second control instruction. Optionally, the performing a path tracking operation based on the second planning information, to generate the second control instruction is implemented by the following steps: determining, based on current position information, a current vehicle speed, and a current yaw angle of the vehicle, a steering angle deviation and a speed deviation required by the vehicle to follow the second planning information; generating the second control instruction based on the determined steering angle deviation and speed deviation required by the vehicle to follow the second planning information, where the second control instruction includes a steering angle control volume and an acceleration/deceleration value control volume; and controlling the vehicle to steer based on the steering angle control volume and controlling the vehicle to accelerate/decelerate based on the acceleration/deceleration value control volume, so that the vehicle drives to a safe parking position according to the second planning information.

In an embodiment, in a process of performing the path tracking operation based on the second planning information, position information of discrete points included in a path in the second planning information, and current position information, a current speed, and a current yaw angle of the vehicle may be obtained, and the path tracking operation may be performed based on the obtained position information of the discrete points included in the path in the second planning information, and the obtained current position information, current speed, and current yaw angle of the vehicle. Specifically, a target yaw angle of the vehicle may be determined based on the position information of the discrete points included in the path in the second planning information and the current position information of the vehicle; a target steering angle of the vehicle may be determined based on the current yaw angle, the target yaw angle, and the current speed of the vehicle; a target speed of the vehicle may be determined based on the position information of the discrete points included in the path in the second planning information and the current yaw angle; a steering angle control volume and an acceleration/deceleration value control volume may be generated respectively based on the determined target steering angle and target speed of the vehicle; and the vehicle may be controlled to steer based on the generated steering angle control volume and the vehicle may be controlled to accelerate/decelerate based on the generated acceleration/deceleration value control volume, so that the vehicle drives to a safe parking position according to the second planning information.

In another embodiment, in the process of performing the path tracking operation based on the second planning information, position information of discrete points included in a path in the second planning information, and current position information, a current speed, and a current yaw angle of the vehicle may be obtained; a discrete point closest to a current position of the vehicle may be selected, from the discrete points included in the path in the second planning information, as a target tracking point; a look-ahead distance l_{d} from the current position of the vehicle (such as a position of a rear axle) to the target tracking point may be determined; an included angle α between a current vehicle body attitude of the vehicle and the target tracking point may be determined; a target steering angle δ(t) of the vehicle may be determined based on the following formula:

$$δ ( t ) = {tan}^{- 1} ( \frac{2 L sin ( α ( t ) )}{{l}_{d}} )$$

where L represents a wheelbase of the vehicle, and α(t) represents an included angle between a vehicle body attitude and the target tracking point at a time t; a target speed of the vehicle may be determined based on the current speed and a desired speed of the vehicle; a steering angle control volume and an acceleration/deceleration value control volume may be generated respectively based on the determined target steering angle and target speed of the vehicle; and the vehicle may be controlled to steer based on the generated steering angle control volume and the vehicle may be controlled to accelerate/decelerate based on the generated acceleration/deceleration value control volume, so that the vehicle drives to a safe parking position according to the second planning information.

Those skilled in the art may understand that the foregoing embodiment of the process of the path tracking operation is only used as an example. Without departing from the spirit and the scope of the disclosure, the path tracking operation may be performed based on the second planning information in other path tracking manners, to generate the second control instruction to control the steering and acceleration/deceleration of the vehicle, so that the vehicle drives to a safe parking position according to the second planning information.

The vehicle control method according to an aspect of the disclosure may be applied to an autonomous driving process of a vehicle. During normal driving of the vehicle, the method may be used to generate, in real time, both planning information for normal driving of the vehicle and planning information for safe parking when the autonomous driving control module fails. This ensures that when the autonomous driving control module fails, the path tracking operation may be performed based on the previously received planning information for safe parking, to control the vehicle to drive to a safe parking position, without the need of an additional autonomous driving control module for control.

According to the above vehicle control method, only a single autonomous driving control module may be used, and safe parking of the autonomous vehicle when the autonomous driving control module fails may be implemented. This improves the autonomous driving safety of the vehicle while reducing the complexity and costs of designing the autonomous driving system.

FIG. 3 is a schematic diagram of path tracking according to an embodiment of the disclosure.

As shown in FIG. 3, as an example, path information in planning information for safe parking are represented by a plurality of coordinate points (x1, y1), (x2, y2), (x3, y3), (x4, y4), (x5, y5), and (x6, y6). In a process of performing a path tracking operation based on planning information for safe parking, a steering angle deviation and a speed deviation required by a vehicle to follow a path for safe parking are determined based on current position information, a current vehicle speed, and a current yaw angle of the vehicle; a steering angle control volume and an acceleration/deceleration value control volume are generated based on the determined steering angle deviation and speed deviation required by the vehicle to follow the path for safe parking; and the lateral control module is controlled based on the generated steering angle control volume and the longitudinal control module is controlled based on the generated acceleration/deceleration value control volume, so that the vehicle drives to a safe parking position according to the planning information for safe parking.

In an embodiment, a tracking point is selected from the plurality of coordinate points (x1, y1), (x2, y2), (x3, y3), (x4, y4), (x5, y5), and (x6, y6) based on the current position information of the vehicle, where the tracking point is a point of the plurality of coordinate points that is closest to the current position of the vehicle and that is located in front of a driving direction of the vehicle; a lateral error and a heading error of the tracking point selected for following by the vehicle are determined based on the current position information of the vehicle, the path for safe parking, and the selected tracking point; and a steering angle control volume of the vehicle is determined by using a Stanley controller based on the lateral error and the heading error, and a lateral control module is controlled based on the determined steering angle control volume of the vehicle, so that the vehicle drives to a safe parking position based on planning information for safe parking. Those skilled in the art may understand that the Stanley controller is a controller for path tracking of an autonomous vehicle that is designed based on a Stanley algorithm. The Stanley algorithm is a method based on geometric tracking and is a nonlinear feedback function based on a cross-track error (CTE), and can allow for the cross-track error to exponentially converge to 0.

Those skilled in the art may understand that the foregoing embodiment of the process of the path tracking operation is only used as an example. Without departing from the spirit and the scope of the disclosure, the path tracking operation may be performed based on planning information for safe parking in other path tracking manners, to generate the second control instruction to control the steering and acceleration/deceleration of the vehicle, so that the vehicle drives to a safe parking position according to the planning information for safe parking.

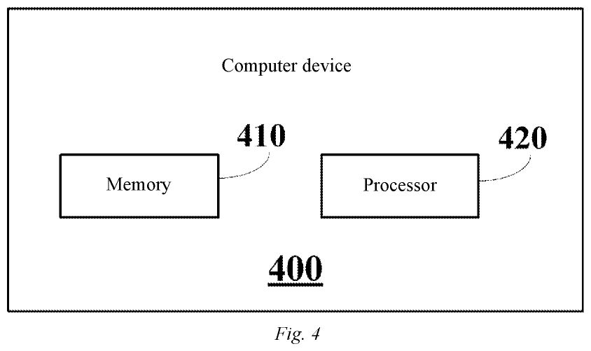

FIG. 4 is a block diagram of a computer device for implementing the vehicle control method of the disclosure according to an aspect of the disclosure. As shown in FIG. 4, a computer device 400 includes a memory 410 and a processor 420. Although not shown, the computer device 400 further includes a computer program stored on the memory 410 and executable on the processor 420. The processor 420, when executing the computer program, implements steps of the vehicle control method according to an aspect of the disclosure, for example as shown in FIG. 2.

In addition, as described above, the disclosure may also be implemented as a computer storage medium, which has stored therein a program for causing a computer to perform the vehicle control method according to an aspect of the disclosure.

Here, various forms of computer storage media, such as disks (for example, a magnetic disk, an optical disc, etc.), cards (for example, a memory card, an optical card, etc.), semiconductor memories (for example, a ROM, a non-volatile memory, etc.), and tapes (for example, a magnetic tape, a cassette tape, etc.) may be used as the computer storage medium.

According to the vehicle control system and the vehicle control method provided in the disclosure, only a single autonomous driving control module may be used, and safe parking of the autonomous vehicle when the autonomous driving control module fails may be implemented. This improves the autonomous driving safety of the vehicle while reducing the complexity and costs of designing the autonomous driving system.

The embodiments and examples proposed herein are provided to describe as adequately as possible embodiments according to the disclosure and specific applications thereof and thus enable those skilled in the art to implement and use the disclosure. However, those skilled in the art will know that the above descriptions and examples are provided only for description and illustration. The proposed description is not intended to cover all aspects of the disclosure or limit the disclosure to the disclosed precise forms.

1. A vehicle control system, comprising:
an autonomous driving control module configured to generate first planning information and second planning information in real time based on vehicle environment information, vehicle status information, and vehicle destination information, wherein the second planning information is used for safe parking; and
a vehicle dynamic control module configured to receive the first planning information and the second planning information from the autonomous driving control module in real time, to generate a first control instruction based on the received first planning information or generate a second control instruction based on the received second planning information.

2. The vehicle control system according to claim 1, wherein the vehicle dynamic control module is further configured to:
detect a status of communication with the autonomous driving control module and an operating status of the autonomous driving control module in real time, to determine whether the autonomous driving control module has failed; and
generate the first control instruction based on the received first planning information upon determining that the autonomous driving control module has not failed, and generate the second control instruction based on the received second planning information upon determining that the autonomous driving control module has failed.

3. The vehicle control system according to claim 2, wherein the vehicle dynamic control module is further configured to:
determine that the autonomous driving control module has failed upon detecting that at least one of the status of communication with the autonomous driving control module and the operating status of the autonomous driving control module is abnormal; and
determine that the autonomous driving control module has not failed upon detecting that the status of communication with the autonomous driving control module and the operating status of the autonomous driving control module are normal.

4. The vehicle control system according to claim 1, wherein the vehicle control system further comprises:
a lateral control module configured to control steering of a vehicle based on the first control instruction or the second control instruction from the vehicle dynamic control module; and
a longitudinal control module configured to control acceleration/deceleration of the vehicle based on the first control instruction or the second control instruction from the vehicle dynamic control module.

5. The vehicle control system according to claim 4, wherein the first control instruction comprises a steering angle and an acceleration/deceleration value, and the vehicle dynamic control module is further configured to:
send the steering angle to the lateral control module to control the steering of the vehicle; and
send the acceleration/deceleration value to the longitudinal control module to control the acceleration/deceleration of the vehicle.

6. The vehicle control system according to claim 4, wherein the vehicle dynamic control module further comprises a path tracking submodule, and the path tracking submodule is configured to perform a path tracking operation based on the second planning information, to generate the second control instruction.

7. The vehicle control system according to claim 6, wherein the path tracking submodule is further configured to perform a path tracking operation based on the second planning information, to generate the second control instruction by the following steps:
determining, based on current position information, a current vehicle speed, and a current yaw angle of the vehicle, a steering angle deviation and a speed deviation required by the vehicle to follow the second planning information;
generating the second control instruction based on the determined steering angle deviation and speed deviation required by the vehicle to follow the second planning information, wherein the second control instruction comprises a steering angle control volume and an acceleration/deceleration value control volume; and
controlling the lateral control module based on the steering angle control volume and controlling the longitudinal control module based on the acceleration/deceleration value control volume, so that the vehicle drives to a safe parking position according to the second planning information.

8. A vehicle control method, comprising the following steps:
generating first planning information and second planning information in real time based on vehicle environment information, vehicle status information, and vehicle destination information, wherein the second planning information is used for safe parking;
detecting a status of communication between a vehicle dynamic control module and an autonomous driving control module and an operating status of the autonomous driving control module in real time, to determine whether the autonomous driving control module has failed; and
generating the first control instruction based on the first planning information upon determining that the autonomous driving control module has not failed, and generating the second control instruction based on the second planning information upon determining that the autonomous driving control module has failed.

9. The vehicle control method according to claim 8, wherein the method further comprises:
determining that the autonomous driving control module has failed upon detecting that at least one of the status of communication between the vehicle dynamic control module and the autonomous driving control module and the operating status of the autonomous driving control module is abnormal; and
determining that the autonomous driving control module has not failed upon detecting that the status of communication between the vehicle dynamic control module and the autonomous driving control module and the operating status of the autonomous driving control module are normal.

10. The vehicle control method according to claim 8, wherein the first control instruction comprises a steering angle and an acceleration/deceleration value, and the method further comprises:
controlling steering of a vehicle based on the steering angle; and
controlling acceleration/deceleration of the vehicle based on the acceleration/deceleration value.

11. The vehicle control method according to claim 8, wherein the method further comprises:
performing a path tracking operation based on the second planning information, to generate the second control instruction.

12. The vehicle control method according to claim 11, wherein the performing a path tracking operation based on the second planning information, to generate the second control instruction is implemented by the following steps:
determining, based on current position information, a current vehicle speed, and a current yaw angle of the vehicle, a steering angle deviation and a speed deviation required by the vehicle to follow the second planning information;
generating the second control instruction based on the determined steering angle deviation and speed deviation required by the vehicle to follow the second planning information, wherein the second control instruction comprises a steering angle control volume and an acceleration/deceleration value control volume; and
controlling the vehicle to steer based on the steering angle control volume and controlling the vehicle to accelerate/decelerate based on the acceleration/deceleration value control volume, so that the vehicle drives to a safe parking position according to the second planning information.

13. A computer storage medium, comprising instructions, wherein when the instructions are run, the method according to claim 8 is performed.

14. A computer device, comprising a memory, a processor, and a computer program stored on the memory and executable on the processor, wherein the processor, when executing the program, implements the method according to claim 8.

15. A vehicle, comprising the vehicle control system according to claim 1.

16. A computer storage medium, comprising instructions, wherein when the instructions are run, the method according to claim 9 is performed.

17. A computer device, comprising a memory, a processor, and a computer program stored on the memory and executable on the processor, wherein the processor, when executing the program, implements the method according to claim 9.

18. A vehicle, comprising the vehicle control system according to claim 3.

19. A computer storage medium, comprising instructions, wherein when the instructions are run, the method according to claim 10 is performed.

20. A computer device, comprising a memory, a processor, and a computer program stored on the memory and executable on the processor, wherein the processor, when executing the program, implements the method according to claim 10.
